(19) United States
(12) Patent Application Publication
(10) Pub. No.: US 2012/0169238 A1
(43) Pub. Date: Jul. 5, 2012

(54) COLOR CONTROL OF LIGHTING SYSTEM

(75) Inventor: Egbert Lenderink, Eindhoven (NL)

(73) Assignee: KONINKLIJKE PHILIPS ELECTRONICS N.V., EINDHOVEN (NL)

(21) Appl. No.: 13/392,881

(22) PCT Filed: Sep. 16, 2010
(86) PCT No.: PCT/IB10/54184

§ 371 Date: Feb. 28, 2012

(30) Foreign Application Priority Data
Sep. 23, 2009 (EP) 09171040.0

(51) Int. Cl. H05B 37/02

(52) U.S. Cl. 315/151; 315/294

(57) ABSTRACT

The present invention relates to a method for color control of a lighting system (10) comprising a first (1) and a second (2) light source configured to emit light of different primary colors. By means of the invention, it is possible to determine a color point (cp₃) for mixed light emitted by the first (1) and the second (2) light sources having a minimal difference in perceived color output as compared to a target color point (cpᵣ).

### TECHNICAL FIELD

The present invention relates to a method for color control of a lighting system having two differently colored light sources. The present invention also relates to a corresponding lighting system.

### BACKGROUND OF THE INVENTION

Recently, much progress has been made in increasing the brightness of light emitting diodes (LEDs). As a result, LEDs have become sufficiently bright and inexpensive to serve as a light source in for example lighting systems with adjustable color. By mixing differently colored LEDs any number of colors can be generated, e.g. white. An adjustable color lighting system is typically constructed by using a number of primary colors, and in one example, the three primaries red, green and blue are used. The color of the generated light is determined by the LEDs that are used, as well as by the mixing ratios. To generate “white”, all three LEDs have to be turned on. To be suitable for various applications it is important that the illumination system is adapted to emit light with a desired color output.

Several illumination systems have been developed wherein LEDs of various colors are combined, and where each LED can be driven separately to provide color control of the combined light emitted from the illumination system to obtain a desired color output suitable for the application in question. Such control can be performed by means of for example calibration tables, temperature feedback, flux or color feedback, etc. As one step, the target color point is translated to desired flux from each individual channel, which is a straightforward calculation when there are three primary colors in the system. However, when a target color point is situated outside the color gamut what the light source of an illumination system may produce, an approximation of the target color point may be performed. An example of such a method is disclosed in WO 2007/042984.

Even though the method of WO 2007/042984 provides an approximation to a target color point, it focuses on large scale lighting system with high flexibility in color control, and it may thus be desirable to provide a method for color control for a less complex lighting system having a smaller degree of freedom of color control.

### SUMMARY OF THE INVENTION

According to an aspect of the invention, the above need is at least partly met by a method for color control of a lighting system comprising a first and a second light source configured to emit light of different primary colors, the method comprising the steps of receiving a user-selected target color point arranged in a predetermined two-dimensional color coordinate system, determining a first and a second color point for the first and the second light source, respectively, wherein the first and the second color points are arranged on a straight line in the predetermined two-dimensional color coordinate system, determining a third color point on the line between the first and the second color points, the third color point having a minimal color difference compared to the user-selected target color point, and determining a set of control parameters for the first and the second light source based on the third color point, such that a mixture of light emitted by the first and the second light sources corresponds to the third color point.

Through the method according to the present invention, the third color point is actively determined to be the one of all color points on the line between the first and second color point in the two-dimensional color coordinate system that has the minimal color difference compared to the target color point. In other words, a requested target color having a target color point outside the line, which line comprises the color points that the first and second light source are able to produce together, may be output as a third color point which is situated on the line, with minimal differences in perceived color output.

In a preferred embodiment, the determination of the third color point may further comprise forming a color difference function of positions on the line between the first and the second color points compared to the user-selected target color point and finding a minimal color difference, which function facilitates expressing the color difference between the points on the line and the target color point.

Different methods are possible for finding a minimal color difference when having a color difference function at hand, and in a preferred embodiment the finding of a minimal color difference may comprise determining a derivative equaling zero for the color difference function. Alternatively, it may also be possible to determine the point where the line between the first and second color points intersects with a line perpendicular to it, passing through the target color point.

Preferably, the control parameters are at least one of duty cycles and drive current settings depending on the type of dimming method used for controlling the light sources of the lighting system. Also, the method of the present invention may further comprise acquiring sensor data for each of the first and the second light sources for determining their respective color points. The primary color points may hence be determined based on sensor data. With such feedback abilities, color points reflecting the current circumstances may be retrieved by the lighting system, whereby measures to adapt to these circumstances may be performed. Initial values are for instance stored within the lighting system, and updated in accordance with the measurements during operation.

Preferably, the predetermined two-dimensional color coordinate system may correspond to the CIE 1976 color coordinate system. Two-dimensional depictions of the CIE 1976 coordinate system are chromaticity diagrams, wherein the colors have a fixed lightness. The advantage of the CIE 1976 color coordinate system is that there is a good correlation between perceivable color differences and the geometrical distance between color points in this coordinate system.

According to another aspect of the invention there is provided a lighting system, comprising a first and a second light source configured to emit light of different primary colors, a sensor for detecting light emitted by the first and the second light source, and a control unit configured to receive a user-selected target color point arranged in a predetermined two-dimensional color coordinate system, to determine a first and a second color point for the first and the second light source, respectively, wherein the first and the second color points are arranged on a straight line in the predetermined two-dimensional color coordinate system, to determine a third color point on the line between the first and the second color points the third color point having a minimal color difference compared to the user-selected target color point, and to determine a set of control parameters for the first and the second light source based on the third color point, such that a mixture of light emitted by the first and the second light sources corresponds to the third color point. With such a lighting system, similar effects as described in conjunction with the first aspect of the invention may be accomplished.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIG. 1 illustrates a lighting system according to a currently preferred embodiment of the present invention;

FIG. 2 shows a color space chromaticity diagram; and FIG. 3 is a flow chart of the method steps according to the invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person. Like reference characters refer to like elements throughout.

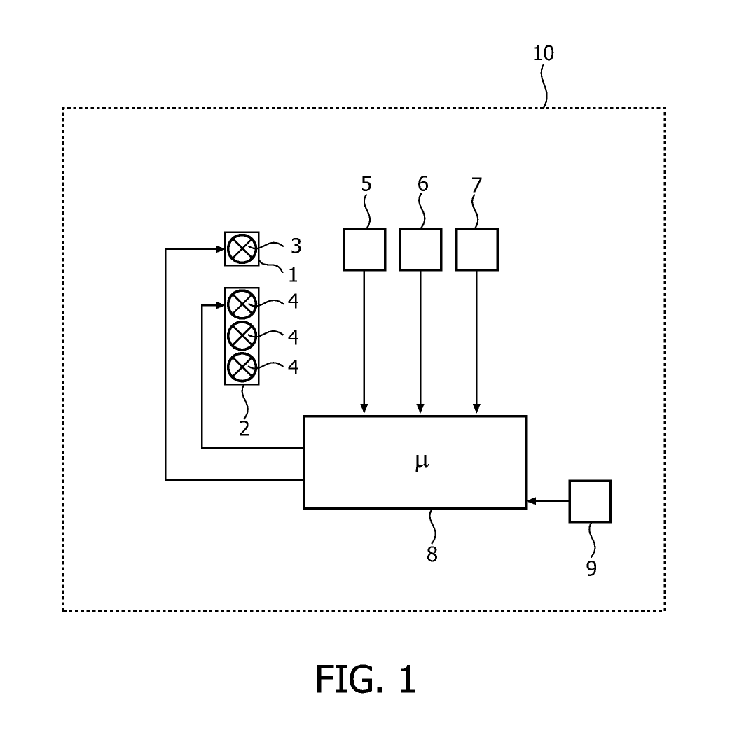

Referring now to the drawings and to FIG. 1 in particular, there is depicted an exemplifying lighting system 10 comprising a first light source 1 and a second light source 2. The first light source 1 here comprises a single LED 3 combined with phosphor, adapted to emit essentially white light. The second light source 2 here comprises three LEDs 4, each adapted to emit essentially red light. Hence, the first light source 1 emits a first primary color, whereas the second light source 2 emits a second primary color. The scope of the invention naturally covers other combinations of LEDs, emitting other primary colors than those illustrated in FIG. 1.

A color sensor 5, and a temperature sensor 6 may be provided. The color sensor is a sensor adapted to give the color coordinates (e.g. CIE X,Y) of the emitted light, i.e. to measure the color coordinate of the individual primary colors. The temperature sensor 6 may be adapted to determine a surrounding temperature and/or a substrate temperature of the LEDs 3, 4. Also, a flux sensor 7 adapted to give a single flux number of the emitted light may be used with a drive- and measurement scheme which allows to determine the fluxes of the two light sources 1 and 2, separately. The spectral sensitivity of the flux sensor 7 must be known in order to be able to make the essential computations from its readings. The flux sensor may be a photometric flux sensor, with a sensitivity spectrum resembling the human eye sensitivity, or a radiometric flux sensor, with a sensitivity spectrum determined by the material characteristic of the sensor. It should be noted that the above mentioned sensors respectively are provided in the vicinity of the light sources 1, 2 to provide measurement values for a luminous flux and/or color for each of the LEDs 3, 4.

In the depicted embodiment a control unit 8 is provided, which may be adapted to receive measurement values from the sensors 5, 6, 7 and a predetermined target color. The control unit 8 may include a microprocessor, microcontroller, programmable digital signal processor or another programmable device. The control unit 8 may also, or instead, include an application specific integrated circuit, a programmable gate array or programmable array logic, a programmable logic device, or a digital signal processor. Where the control unit 8 includes a programmable device such as the microprocessor, microcontroller or programmable digital signal processor mentioned above, the processor may further include computer executable code that controls operation of the programmable device. Should the control unit 8 comprise a programmable device such as the microprocessor or microcontroller mentioned above, the processor may further include computer executable code that controls operation of the lighting system 10. The control unit 8 may additionally comprise a regulator, which enables duty cycles and or current levels for the first and second light source 1, 2, to be adjusted.

The lighting system 10 may furthermore comprise a user interface 9. The user interface 9 may include user input devices such as buttons and adjustable controls, which produce a signal or voltage, for instance a digital signal corresponding to a high and a low digital state. If the voltage is in the form of an analog voltage, an analog to digital converter (A/D) may be used to convert the voltage into a useable digital form (not shown). Via the user interface 9, a user may be able to select a desired color.

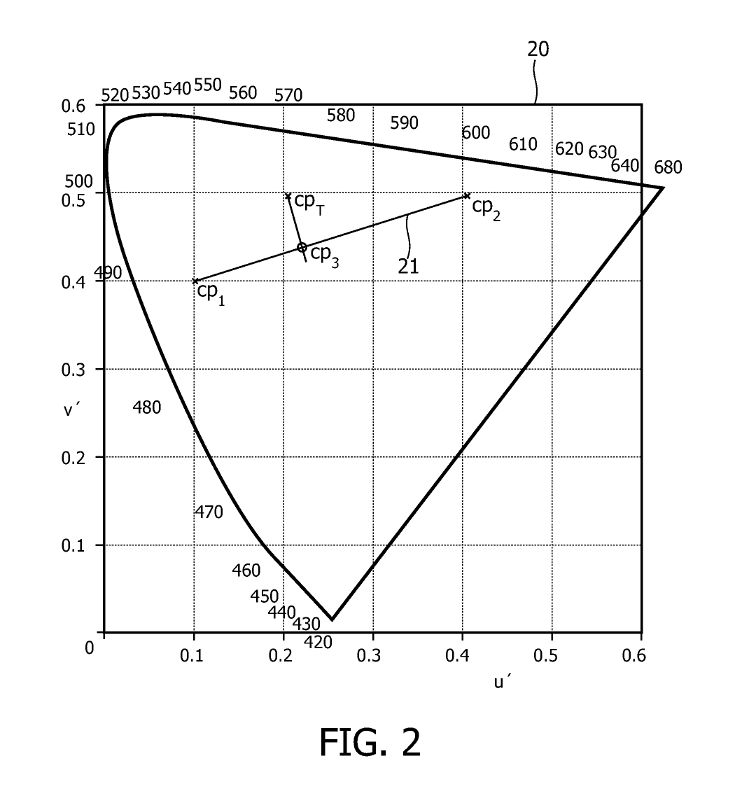

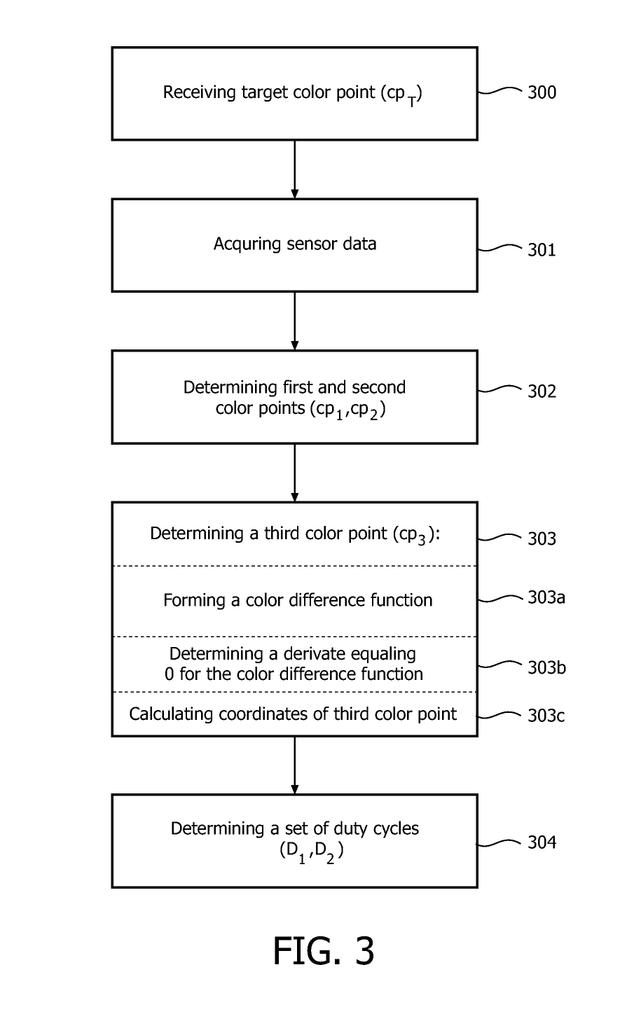

FIG. 2 illustrates a color space chromaticity diagram 20 expressed in a two dimensional space, CIE1976 u′, v′, depicting color points denoted cp₁, cp₂, cp_{T}, cp₃. Cp₁ is the color point produced by the first light source 1, and cp₂ is the color point produced by the second light source 2. The light sources emitting light at two different primary colors have a combined light output somewhere on the straight line 21 depicted in between cp₁ and cp₂. Cp_{T} is the target color point, and cp₃ is the color point determined by the method of the present invention, which is the color point on the straight line in the color space having the smallest distance from the target color point cp_{T}.

FIG. 3 presents exemplifying steps for determining a third color point cp₃ to be output by the lighting system 10 of the shown embodiment. The steps may for instance be performed by a computer program, when executed in the control unit 8 of the lighting system 10. It should be noted that some of the following steps may be performed in another order than suggested, or even simultaneously.

In use, the desired color at which the lighting system 10 should provide light is determined. Thus, in a first step 300, a target color point cp_{T} input value representing a desired set point may be identified. In the described embodiment, this value may be retrieved from the user interface 9, however the skilled person realizes that the value likewise may be derived from for instance another electrical system, or from predetermined settings. The retrieved target color point cp_{T} is here located beside the line 21 comprising the color points that can be rendered by the lighting system.

In the next step 301, in order to identify the current positions of the first and second color points, cp₁, cp₂, measurement values from one or a combination of at least one temperature sensor 6, color sensor 5 and flux sensor 7 are preferably acquired. Additionally, to retrieving measurement values to determine the values of the color points, initial predetermined values known from nominal values or from calibration of the lighting system 10, may be utilized. The nominal flux at nominal current for the two light sources are known by the system at all times, in the form of a calibration matrix. The calibration matrix may be used in two forms, e.g. denoted A and B, where the B form may be calculated from the A form and vice versa, by the standard calculation rules for the three CIE1931 tristimulus values X, Y, Z and the CIE1931 color coordinates x, y, for example as:

$$A = [ \begin{matrix}{Y}_{1} {Y}_{2} \\ {x}_{1} {x}_{2} \\ {y}_{1} {y}_{2}\end{matrix} ] , B = [ \begin{matrix}{X}_{1} {X}_{2} \\ {Y}_{1} {Y}_{2} \\ {Z}_{1} {Z}_{2}\end{matrix} ]$$

$${x}_{i} = \frac{{X}_{i}}{{X}_{i} + {Y}_{i} + {Z}_{i}} , {y}_{i} = \frac{{X}_{i}}{{X}_{i} + {Y}_{i} + {Z}_{i}} , where i = 1 , 2$$

Subsequently, in step 302, the color points cp₁, cp₂, cp_{T} are determined and mapped to the two dimensional space, CIE1976 u′, v′. The color points are given by cp₁=u′₁, v′₁, cp₂=u′₂, v′₂, and cp_{T}=u′_{T}, v_{T}, transformed according to the standard transformation

$${u}_{i}^{′} = \frac{4 {x}_{i}}{12 {y}_{i} - 2 {x}_{i} + 3} , {v}_{i}^{′} = \frac{9 {y}_{i}}{12 {y}_{i} - 2 {x}_{i} + 3} , where i = 1 , 2 , T$$

Next, in step 303 the third color point is determined, according to the following. That is, the line between the first and second color point may be described using a parameter α.

u′(α)→u′₁+α(u′₂−u′₁),v′(α)=v′₁+α(v′₂−v′₁).

In the next step 303a a color difference function is formed, describing the distance D between the points on the line and the target color point cp_{T}, given by the following equation:

D²=(u′_{T}−u′(α))²+(v′_{T}−v′(α))²

In the following step 303b, the derivative of the difference function with respect to α, equaling 0, that is

$$\frac{d}{d α} {D}^{2} = 0 ,$$

is determined to find the value of α having the minimum distance to the target color point cp_{T}:

$$α = \frac{\text{?}}{\text{?}}$$

$$\text{?} \text{indicates text missing or illegible when filed}$$

In step 303c, substituting the value for a in the equation for u′ and v′ gives the third color point cp₃. The third color point cp₃ is transferred back to the x, y coordinate frame via the inverse transformation:

$${x}_{3} = \frac{9 \text{?}}{6 \text{?} - 16 \text{?} + 12} , {y}_{3} = \frac{4 \text{?}}{6 \text{?} - 16 \text{?} + 12}$$

$$\text{?} \text{indicates text missing or illegible when filed}$$

In the next step 304, a set of duty cycles for the first and second light source, respectively, are determined. That is, the color coordinates to obtain the third color point cp₃ are converted to lighting system control parameters, which in the present example are duty cycles of the pulse width modulation waveform (as discussed above, the control parameters may be drive current settings depending on the type of dimming method used for controlling the light sources of the lighting system) used for controlling the LEDs 3, 4 of the lighting system 10. Using input from the B form of the calibration matrix, following equations are achieved:

$$\{ \begin{matrix}{D}_{1} {Y}_{1} + {D}_{2} {Y}_{2} = {Y}_{T} \\ {D}_{1} {X}_{1} + {D}_{2} {X}_{2} = {X}_{3} = \text{?}\end{matrix} \\ \text{?} \text{indicates text missing or illegible when filed}$$

which gives

$$\{ \begin{matrix}{D}_{1} = {Y}_{T} \frac{\text{?} - \text{?}}{\text{?} - \text{?}} \\ {D}_{2} = {Y}_{τ} \frac{\text{?} - \text{?}}{\text{?} - \text{?}}\end{matrix} \\ \text{?} \text{indicates text missing or illegible when filed}$$

Alternatively, the required drive currents for direct current (dc) modulation can be computed in a similar way.

Even though the invention has been described with reference to specific exemplifying embodiments thereof, many different alterations, modifications and the like will become apparent for those skilled in the art. Variations to the disclosed embodiments can be understood and effected by the skilled person in practicing the claimed invention, from a study of the drawings, the disclosure, and the appended claims.

Furthermore, in the claims, the word “comprising” does not exclude other elements or steps, and the indefinite article “a” or “an” does not exclude a plurality.

1. Method for color control of a lighting system comprising a first and a second light source configured to emit light of different primary colors, the method comprising:
receiving a user-selected target color point (cp_{T}) arranged in a predetermined two-dimensional color coordinate system
determining,a first (cp₁) and a second (cp₂) color point, for the first and the second light source, respectively, wherein the first (cp₁) and the second (cp₂) color points are arranged on a straight line in the predetermined two-dimensional color coordinate system
determining a third color point (cp₃) on the line between the first (cp₁) and the second (cp₂) color points, the third color point (cp₃) having a minimal color difference compared to the user-selected target color point (cp_{T}), and
determining a set of control parameters (D₁, D₂) for the first and the second light source based on the third color point (cp₃), such that a mixture of light emitted by the first and the second light sources corresponds to the third color point (cp₃).

2. Method according to claim 1, wherein the determination of the third color point (cp₃) comprises forming a color difference function of positions on the line between the first (cp₁) and the second (cp₂) color points compared to the user-selected target color point (cp_{T}) and finding a minimal color difference.

3. Method according to claim 2, wherein finding the minimal color difference comprises determining a derivative equaling zero for the color difference function.

4. Method according to claim 1, wherein the control parameters (D1, D2) are at least one of duty cycles and drive current settings.

5. Method according to claim 1, further comprising acquiring sensor data for each of the first and the second light sources for determining their respective color points (cp₁, cp₂)

6. Method according claim 1, wherein the predetermined two-dimensional color coordinate system,corresponds to the CIE 1976 color coordinate system.

7. Lighting system comprising:
a first and a second light source configured to emit light of different primary colors;
a sensor for detecting light emitted by the first and the second light source; and
a control unit configured to
receive a user-selected target color point (cp_{T}) arranged in a predetermined two-dimensional color coordinate system
determine a first (cp₁) and a second (cp₂) color point for the first and the second light source, respectively, wherein the first and the second color points are arranged on a straight line in the predetermined two-dimensional color coordinate system
determine a third color point (cp₃) on the line between the first (cp₁) and the second (cp₂) color points, the third color point (cp₃) having a minimal color difference compared to the user-selected target color point (cp_{T}), and
determine a set of control parameters (D₁, D₂) for the first and the second light source based on the third color point (cp₃); such that a mixture of light emitted by the first and the second light sources corresponds to the third color point (cp₃).

8. Lighting system according to claim 7, wherein the determination of the third color point (cp₃) comprises forming a color difference function of positions on the line between the first (cp₁) and the second (cp₂) color points compared to the user-selected color target point (cp_{T}) and finding a minimal color difference.

9. Lighting system according to claim 8, wherein finding the minimal color difference comprises determining a derivative equaling zero for the color difference function.

10. Lighting system according to claim 7, wherein said light sources comprises LEDs.

11. Lighting system according to claim 9, wherein said first light source comprises at least one red LED, and said second light source comprises at least one blue LED combined with remote phosphor.
